(19) United States
(12) Patent Application Publication
(10) Pub. No.: US 2021/0114682 A1
(43) Pub. Date: Apr. 22, 2021

(54) A bicycle

(71) Applicant: Pierpaolo Romio, Vicenza (IT)

(72) Inventor: Pierpaolo Romio, Vicenza (IT)

(21) Appl. No.: 16/494,299

(22) PCT Filed: Mar. 28, 2018
(86) PCT No.: PCT/IB2018/052116

§ 371 Date: Sep. 15, 2019

(30) Foreign Application Priority Data
Mar. 29, 2017 (IT) 102017000034402

(51) Int. Cl. B62K 7/04; B62K 3/02; B62M 3/08

(52) U.S. Cl. CPC B62K 7/04; B62M 3/08; B62K 3/02

(57) ABSTRACT

A bicycle includes a frame and a bottom bracket inserted in a housing made in the frame, and has a column, on the head portion of which a saddle is inserted; a headstock that supports a handlebar; a connecting longitudinal member of a bottom portion of the column with the headstock; and a first reinforcing longitudinal member mechanically connected at a first end thereof to the headstock and at a second end thereof to the column. The connecting longitudinal member has, in a first portion close to the junction with the column, a loading section shaped to support the loading of objects or other material, and the housing of the bottom bracket is at a section of the intermediate column between the head portion and the bottom portion.

### FIELD OF APPLICATION

The present invention is generally applicable to the technical sector of bicycles and relates to a bicycle having an improved frame.

More in detail, the present invention relates to a bicycle having a modified frame which allows to improve the portability of loads and the stability of direction in the presence of particularly heavy loads.

### STATE OF THE ART

Bicycle is one of the most used transport means in the world, for this reason this vehicle is of crucial importance in everyone's life.

Bicycle, in fact, allows anyone to move from one place to another with extreme ease, without being affected by traffic, parking or other problems. It can also be used without the need for permits, driving licenses or similar.

Given the frequent use, it often happens that the user needs to carry loads such as shopping bags, bags, books or other.

For this reason, known bicycles present front and rear loading spaces placed over the wheels and on which baskets are generally hooked.

However, these spaces are often small in size, this in order to limit weight and volume of the load placed thereon. This is due to a plurality of factors.

First of all, these loading spaces are usually little resistant in terms of structure and are coupled to the bicycle frame. In this sense, even the coupling points are mechanically fragile, thus not allowing excessive loads.

In the case of the front position, the loads could be too bulky and able to conceal, at least partially, the correct view of the driver constituting a dangerous situation.

Furthermore, the position of the loads is far from the center of gravity of the bicycle, so that excessive weights worsen the stability and driveability of the vehicle. This effect is particularly apparent in the case of the front loading space. An excessive load at this point leads to a noticeable worsening of the control of the handlebar and of the steering, since this load weighs almost totally on the underlying front wheel and on the steering wheel.

### Presentation of the invention

The object of the present invention is to overcome, at least partially, the drawbacks outlined above by providing a bicycle wherein the loading space is closer to the center of gravity of the vehicle with respect to what happens in the prior art.

Another object of the present invention is to provide a bicycle wherein the loading space is able to bear greater weights with respect to what happens in known bicycles, while maintaining the stability of the bicycle and its direction substantially unchanged.

A further object of the present invention is to provide a bicycle wherein the loading space is able to accommodate objects or similar, even particularly bulky, without compromising the driver's view.

Such aims, as well as others which will become clearer below, are achieved by a bicycle according to the following claims, which are to be considered as an integral part of the present disclosure.

In particular, the bicycle of the invention, like other known bicycles, comprises a frame and at least a bottom bracket inserted in a housing made in the frame itself.

In the latter, however, it is possible to identify:
at least one column on the head portion of which a saddle is inserted;
at least one headstock to support a handlebar;
one or more longitudinal members of mechanical connection of a bottom portion of the column with the headstock;
at least one first reinforcing longitudinal member mechanically connected with a first end thereof to the headstock and whit a second end thereof to the column.

According to an aspect of the invention, the connecting longitudinal member has, in a first portion which is close to the joint of the column, a loading section shaped to support the loading of objects or other material.

In other words, an initial section of the connecting longitudinal member (otherwise called down tube in the known frames) is shaped and configured to provide a loading space. Given the configuration of a standard bicycle frame, it is evident that such a position advantageously allows to keep the bicycle stable and easily manageable even in the presence of heavy loads. The loading space, in fact, is provided in a substantially central position and close to the center of gravity of the bicycle and, above all, it does not directly affect either of the two wheels nor, least of all, the steering wheel.

The affected area of the frame is however close to the ground, thus improving the overall management of the bicycle.

According to another aspect of the invention, the housing of the bottom bracket is provided in correspondence of a section of the intermediate column between its head portion and its bottom portion.

Since the reduction of the distance between the saddle and the pedals is detrimental to the user, and since it is not possible to raise the saddle excessively, this characteristic is obtained by keeping the position of the bottom bracket unchanged and moving the lower end of the column downwards. In this way, advantageously, the loading section which starts near the junction between the column and the connecting longitudinal member is also lowered.

In other words, advantageously, in the bicycle of the invention the loading section is lowered towards the ground with respect to known bicycles, further improving the stability of the bicycle since the center of gravity and the loading point as well are lowered.

Still advantageously, the loading space is increased in height.

According to another aspect of the invention, the length of the bottom bracket is increased. In this way, the pedal cranks of the bicycle are moved away from each other. Since in their rotary movement they necessarily involve the loading space, it is evident that this allows, advantageously, to limit, or even to eliminate, this kind of problems.

### BRIEF DESCRIPTION OF THE DRAWINGS

Further features and advantages of the invention will be more evident in light of the detailed description of some of the preferred but not exclusive embodiments of a bicycle according to the invention, illustrated by way of non-limiting example with the aid of the accompanying drawing tables, wherein:

FIG. 1 represents a bicycle according to the invention in front view;

FIG. 2 represents a detail of the bicycle of FIG. 1;

FIG. 3 represents an embodiment of the detail of FIG. 2.

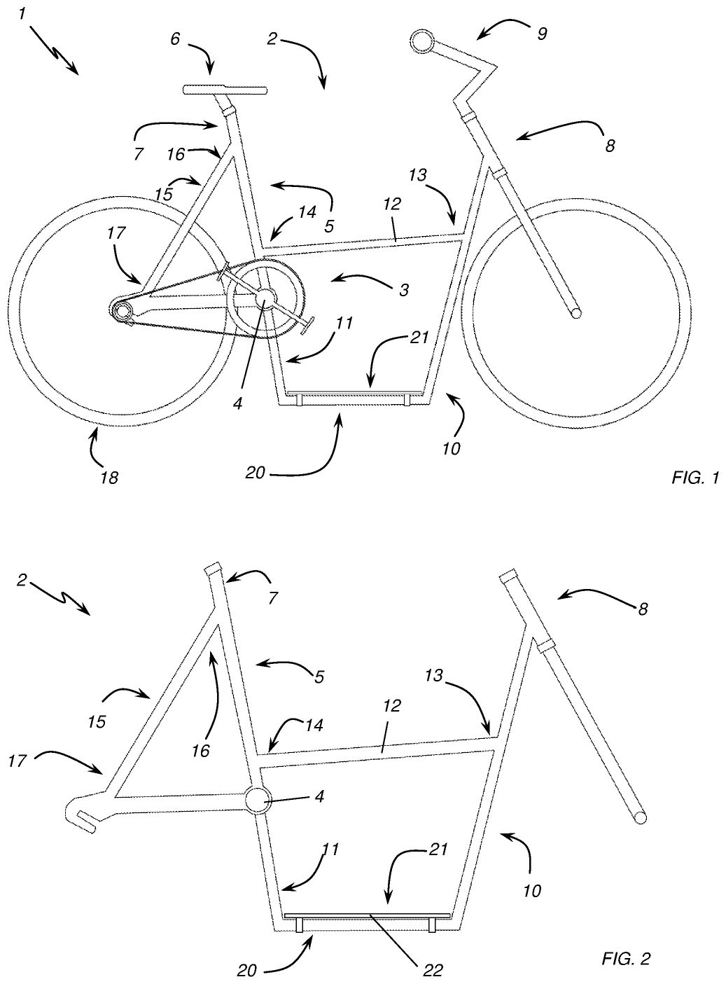

### DETAILED DESCRIPTION OF SOME PREFERRED EMBODIMENT EXAMPLE

With reference to the aforementioned figures, a bicycle 1 is described, the use of which is particularly advantageous in the city.

Like the known bicycles, the bicycle 1 of the invention comprises a frame 2 and a bottom bracket 3 for the locomotion. The latter is inserted in a housing 4 made in the frame 2.

Furthermore, a seat 5 and a saddle 6 can be inserted on the head portion 7 of the column 5. Furthermore, the frame 2 comprises a headstock 8 which supports a handlebar 9.

Then, there is a longitudinal member of mechanical connection 10 of a bottom portion 11 of the column 5 with the headstock 8. In known bicycles it is called “down tube”.

According to an aspect of the invention, the frame 2 also features a first reinforcing longitudinal member 12 mechanically connected with a first end 13 thereof to the headstock 8 and with a second end 14 thereof to the column 5.

In the figures, it is observed that the first reinforcing longitudinal member 12 is connected directly to the column 5 and via the connecting longitudinal member 10 to the headstock 8. Obviously, this execution should not be considered as limiting the invention. In fact, there are, for example, embodiments not shown here, where the first reinforcing longitudinal member is connected directly to the headstock.

Also the number of first reinforcing longitudinal members should not be considered limiting for the invention, as it could be any number. Likewise, the number of bottom brackets, saddles, steering wheels and connecting longitudinal members may also be any.

According to another aspect of the invention, the bicycle 1 preferably, but not necessarily, also comprises a second reinforcing longitudinal member 15 mechanically connected with a first end 16 thereof to the column 5 and with a second end 17 thereof to the rear wheel 18 of the bicycle 1. Although it is clear from the figures that the second reinforcing longitudinal members are two, also in this case the number must not be considered as limiting for the invention, since it may be any.

In the figures, it is observed that the first reinforcing longitudinal members 12 and the second reinforcing longitudinal members 15 are made separately and coupled to the column 5. However, such a detail should not be considered a limiting detail for the invention. According to some executive variations, in fact, they are made in a single body.

In the same figures, it is also observed that the connecting longitudinal member 10 is directly coupled to the headstock 8. However, also this detail must not be considered as limiting for the invention, since it has been said previously that they must be operatively connected and not necessarily directly coupled.

In this sense, according to a possible embodiment, not shown in the figures, the connecting longitudinal member is coupled to the first reinforcing longitudinal member. It is the latter that is coupled directly to the headstock and providing, at the same time, operationally, a mechanical coupling to the headstock also for the connecting longitudinal member.

Likewise, according to another embodiment variant, not shown in the figures as well, both the first reinforcing longitudinal member and the connecting longitudinal member are coupled directly to the headstock.

It is therefore evident that there is a further embodiment which is not yet shown in the figures and according to which both the first reinforcing longitudinal member and the connecting longitudinal member are connected to one end of an additional headstock whose second end is coupled to the headstock.

According to another aspect of the invention, the connecting longitudinal member 10 has, in a first portion 20 which is close to the joint of the column 5, a loading section 21 shaped to support the loading of objects or other material.

Advantageously, therefore, an initial section of the connecting longitudinal member 10 is shaped and configured to provide a loading space which, given its position, is particularly close to the ground. This allows, advantageously, to keep the configuration and the direction of the bicycle 1 stable and easily manageable even in the presence of heavy loads.

The loading section 21, moreover, is located in a substantially central position and close to the center of gravity of the bicycle 1 thereby facilitating the user's guidance. Moreover, still advantageously, it does not directly involve either of the two wheels nor, least of all, the steering.

It is therefore evident, still advantageously, that the load may be more voluminous with respect to those normally allowed with known bicycles, since it does not even hinder the user's view. Moreover, still advantageously, it can be much heavier than those loaded on a known bicycle, without thereby posing danger to the user since there is no substantial worsening of the driving conditions.

Obviously, the presence of the loading section 21 does not exclude the use of the other loading spaces usually present in the known bicycles in the front area and in the rear area.

According to the disclosed embodiment, a plate 22 is coupled to the loading section 21, which makes it possible to conveniently handle the load of objects or other. However, such aspect must not be considered as limiting for the invention. According to some embodiments, in fact, to the same loading section, specific containers are coupled, whereas according to other embodiments, the loading section has itself an appropriate shaping which ensures the stability of the load resting on it.

In the case of containers, according to some embodiments, they have an upper access. According to other variants, however, they have a lateral access to facilitate the arrangement and removal of loads.

According to another embodiment, one or more containers are arranged wrapping the first reinforcing longitudinal member. In this way, this longitudinal member does not constitute an upper limit to the loading space.

Although so far reference has been made to containers to be placed on the loading section 21, it is evident that even such embodiments are not to be considered as limiting for the invention. In particular, according to a further embodiment, the loading section is shaped for carrying a standing passenger or, according to another embodiment, seating on a suitable seat.

According to a further aspect of the invention, the housing 4 of the bottom bracket 3 is provided in correspondence of a portion of a section of the intermediate column 5 between the head portion 7 and the bottom portion 11.

Since, as mentioned, the reduction of the distance between the saddle 6 and bottom bracket 3 can be detrimental to the user, and since it is not possible to raise the saddle 6 excessively, without danger for the user, this characteristic is obtained by keeping the position of the bottom bracket 3 unchanged and moving the lower end of the column 5 downwards.

In this way, advantageously, the loading section 21, which starting near the junction between the bottom of the column 5 and the connecting longitudinal member 10, is arranged close to the ground.

In other words, advantageously, in the bicycle 1 of the invention the loading section 21 is lowered towards the ground, further improving the stability of the bicycle 1 since the center of gravity and the loading point are lowered.

Still advantageously, the space above the loading section 21 is increased in height. This can be totally used for the loading of elements which may therefore be bulky, or it can advantageously allow, as can be seen in the figures, to also lower the first connecting longitudinal member 10. In the latter case, advantageously, the bicycle 1 of the invention can be used more comfortably, facilitating its use in particular to those people who have difficulty in lifting the lower limbs.

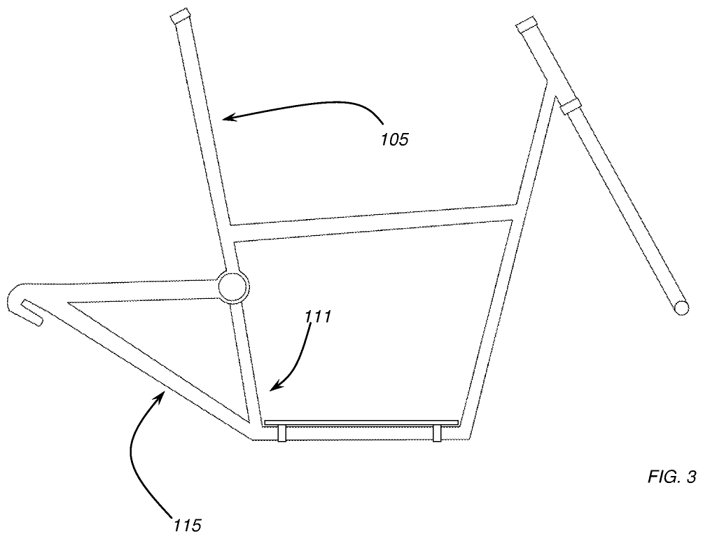

It has been described previously the presence of the second reinforcing longitudinal member 15 mechanically connected with a first end 16 thereof to the column 5 and with a second end 17 thereof to the rear wheel 18 of the bicycle 1. Even if in the figures it is observed that it connects an upper portion of the column 5 to the rear wheel 18, not only, as mentioned, its presence is not to be considered as limiting for the invention, but also this specific configuration must not be considered limiting. In particular, in FIG. 3 it is possible to observe an embodiment of the bicycle of the invention where the second reinforcing longitudinal member 115 joins the rear wheel to the bottom portion 111 of the column 105. As it is immediately clear from the figure, this makes it possible to mechanically reinforce the bicycle, especially in the case of particularly heavy loads.

With respect to the housing 4 of the bottom bracket 3, in the described embodiment, which is shown in the figures, it is formed directly in the intermediate section of the column 5.

However, even this detail must not be considered limiting for different embodiments where, for example, the housing is coupled to a headstock which is in turn coupled to the frame. This also allows, advantageously, to move the bottom bracket horizontally, thus modifying the user position on the bicycle of the invention.

According to another aspect of the invention, the length of the bottom bracket 3 is increased. In this way, the pedal cranks 25 of the bicycle 1 are moved away from each other. Since in their rotary motion they necessarily involve the loading space, it is evident that this allows, advantageously, to limit, or even to eliminate, the possibility of collision between the same pedal cranks 25 and the load placed on the loading section 21.

The elongation of the bottom bracket 3 can be obtained in different ways without any limitation for the present invention. For example, according to some embodiments, special cylinders are added to the ends of the bottom bracket, whereas according to other embodiments, the same bottom bracket is made with a longer body.

In any case, what matters is that while in the bottom brackets the length is usually 14 centimeters, in the case of the invention the length can even reach 22 centimeters or more. This makes it possible to prevent the cranks 25 from colliding with the loads arranged on the loading section 21.

As known, some known bicycles have electric engines often associated with the wheels or with the bottom bracket. Obviously, even in the case of the bicycle 1 of the invention, this can be done comfortably, especially in the case of the bottom bracket 21, since it has an increased length and is therefore particularly suitable for receiving a motor.

In order to increase the loading space, according to a further aspect of the invention, the bicycle 1 has wheels with reduced diameter. In this way, with the same length of the vehicle, the loading section 21 is elongated.

In light of the foregoing, it is possible to understand that the bicycle of the invention achieves all the prefixed objects, overcoming said drawbacks of the prior art.

In particular, the bicycle of the invention has a loading space closer to the center of gravity of the vehicle itself with respect to what happens in the prior art.

Moreover, this loading space can bear higher weights with respect to the known bicycles, while keeping the stability of the bicycle and its direction substantially unchanged.

It is also able to accommodate objects or similar, even particularly bulky, without compromising the driver's view.

The bicycle of the invention is susceptible of numerous modifications and variations, all of which fall within the inventive concept expressed in the attached claims. All the details may furthermore be replaced by other technically equivalent elements, and the materials may be different depending on the needs, without departing from the scope of the invention.

Although the bicycle of the invention has been described with particular reference to the accompanying figures, the reference numbers used in the description and claims are used to improve the intelligence of the invention and do not constitute any limitation to the claimed scope of protection.

The invention claimed is:

1. A bicycle comprising:
a frame (2); and
at least one bottom bracket (3) engaged in a housing (4) made in said frame (2),
wherein the bicycle has:
at least one column (5, 105), on a head portion (7) of which a saddle (6) is inserted;
at least one headstock (8) adapted to support a handlebar (9);
one or more longitudinal members (10) that mechanically connect a bottom portion (11, 111) of said column (5, 105) with said headstock (8);
at least one first reinforcing longitudinal member (12) mechanically connected at a first end (13) thereof to said headstock (8) and at a second end (14) thereof to said column (5, 105), and wherein:
said connecting longitudinal member (10) has, in a first portion (20) in proximity to a joint of the column (5, 105), a loading section (21) shaped to support a load of objects or other material, and
said housing (4) is made in correspondence of a portion of a section of said column (5, 105) between said head portion (7) and said bottom portion (11, 111), said first portion (20) being disposed in proximity of a ground so as to bring the load closer to a center of gravity of the bicycle.

2. The bicycle according to claim 1, wherein a length of said bottom bracket (3) extends so as to separate pedal cranks (25) from each other and to prevent free ends of the pedal cranks from interfering with said loading section (21) during rotation.

3. The bicycle according to claim 1, further comprising at least one second reinforcing longitudinal member (15, 115) mechanically connected at a first end (16) thereof to said column (5, 105) and at a second end (17) thereof to the a rear wheel (18) of said bicycle (1).

4. The bicycle according to claim 3, wherein said first and second reinforcing longitudinal members are made as a single body.

5. The bicycle according to claim 1, wherein said connecting longitudinal member is coupled to said first reinforcing longitudinal member and is mechanically connected to said headstock by said first reinforcing longitudinal member.

6. The bicycle according to claim 1, wherein said first reinforcing longitudinal member (12) is coupled to said connecting longitudinal member (10) and is mechanically connected to said headstock (8) by said connecting longitudinal member.

7. The bicycle according to claim 1, further comprising a plate (22) coupled to said loading section (21) of said connecting longitudinal member (10) and adapted to support objects or other material.

8. The bicycle according to claim 1, wherein said housing (4) of said bottom bracket (3) is formed in said intermediate section of said column (5, 105).

9. The bicycle according to claim 1, wherein said housing engaging said bottom bracket is coupled to a longitudinal member protruding from said column.
